(19) United States
(12) Patent Application Publication
(10) Pub. No.: US 2024/0403769 A1
(43) Pub. Date: Dec. 5, 2024

(54) Adaptive risk engine

(71) Applicant: Wells Fargo Bank, N.A., San Francisco, CA (US)

(72) Inventor: Armando Lemos, New Rochelle, NY (US)

(21) Appl. No.: 17/304,670

(22) Filed: Jun. 24, 2021

(51) Int. Cl. G06Q 10/06; G06F 16/28; G06N 20/00

(52) U.S. Cl. CPC G06Q 10/0635; G06F 16/287; G06N 20/00

(57) ABSTRACT

Based on data elements from different sources, including risk metrics, control description, policy data, authoritative sources, regulatory input and requirements described in natural language, applied combinations of data correlation principles create an adaptive data technology solution using statistical and logical computational methods to identify natural language correlation between different data categories such as process definitions, risk statements, and control data points to create applicability indexes and cross-walk lineage vectors to help risk identification and remediation.

### BACKGROUND

Financial institutions handle large quantities of information. Risk management efforts often begin as focused attempts to improve certain risk or compliance management elements within one functional area, such as information technology, security, or finance. The function takes on the challenge of building a defined approach to methodically review risk or catalog compliance obligations to ensure that an organization's individual piece is properly tracking towards its objectives.

### SUMMARY

Embodiments of the disclosure are directed to leveraging natural language processing to evaluate aggregated internal efforts to address regulatory concerns.

According to aspects of the present disclosure, a system comprises: one or more processors; and non-transitory computer-readable storage encoding instructions which, when executed by the one or more processors, causes the system to: receive data associated with rules from one or more data sources, parse the data into individual data elements; associate the individual data elements with one of the category types, including to: process the data elements using a natural language processing module to identify one of the predefined category types, generate a model using the predefined category identified by the natural language processing module; and based on the match: (i) create a lineage vector; or (ii) create a new category corresponding to the received data; and automatically perform an action associated with the risk assessment based on the associated category type displayed on a dashboard for reporting.

In another aspect, a computer-implemented method of performing risk assessment comprises: receiving risk-related data associated with rules from one or more data sources, wherein the data source contains risk metrics, parsing the risk-related data into individual data elements, associating the individual data elements with one of the risk category types, including: processing the data elements using a natural language processing module to identify one of the predefined risk category types, generating a model using the predefined risk category identified by the natural language processing engine; and based on the match: (i) creating a lineage vector; or (ii) creating a new category corresponding to the received data; and automatically performing an action associated with the risk assessment based on the associated category type displayed on a dashboard for reporting, wherein the risk assessment performs one or more actions concerning the impacted assessments and/or to modify the already generated model.

Yet another aspect is directed to a system for managing a risk assessment process for a financial industry. The system comprises: one or more processors; and non-transitory computer-readable storage encoding instructions which, when executed by the one or more processors, causes the system to: receive financial data associated with requirements from one or more data sources, wherein a data source is a financial institution, parse the financial data into individual data elements, associate the individual data elements with one of the financial category types, including to: process the data elements using a natural language processing module to identify a financial category type, generate a model using the financial category identified by the natural language processing engine; and based on the match: (i) create a lineage vector; or (ii) create a new category corresponding to the received financial data; and automatically perform an action associated with the risk assessment based on the associated financial category type displayed on a graphical user interface on a financial institution device.

The details of one or more techniques are set forth in the accompanying drawings and the description below. Other features, objects, and advantages of these techniques will be apparent from the description, drawings, and claims.

### DESCRIPTION OF THE DRAWINGS

FIG. 1 schematically shows an example system that provides an analysis of data elements described in natural language.

FIG. 2 schematically shows an example server device of the system of FIG. 1.

FIG. 3 schematically shows an example adaptive risk engine of the server of FIG. 2.

FIG. 4 schematically shows an example natural processing language module of the adaptive risk engine of FIG. 3.

FIG. 5 schematically shows an example graphical user interface of the server device of FIG. 2.

FIG. 6 is an example process flow that can be performed by the system of FIG. 1.

FIG. 7 is another example process flow that can be performed by the system of FIG. 1.

FIG. 8 schematically shows an example physical components of portions of the system of FIG. 1.

### DETAILED DESCRIPTION

Financial institutions handle large quantities of information. Some of that information contains imperative data that can influence business decisions in all realms of financial institution dealings. Based on data elements from different sources, including risk metrics, control description, policy data, authoritative sources, regulatory input and requirements described in natural language, the disclosed embodiment seek to apply a combination of data correlation principles to create an adaptive data technology solution using statistical and logical computational methods to identify natural language correlation between different data categories such as process definitions, risk statements and control data points to create applicability indexes and cross-walk lineage vectors to help risk identification and remediation.

The drivers for this effort can be many-regulatory pressure from an external entity, strategic acknowledgment by executives, or bottom-up efforts by front-line managers to reduce risks. Eventually, this function designates resources, implements processes, and utilizes some technologies to address risk and compliance issues.

As more functions understand that risk and compliance management is part of managing business operations, more risk management processes are created. As the implementations become more mature, the organization realizes there are significant benefits to streamlining processes, reducing efforts, and eliminating redundant activities.

The concept relates to a system that leverages natural language processing to evaluate internal efforts within an organization (in the aggregate) to address regulatory concerns and to provide an actionable dashboard to address gaps and eliminate redundancies.

The system provides an analysis of data elements from different sources, including risk metrics, control description, policy data, authoritative sources, regulatory input, and requirements described in natural language. A combination of data correlation principles using statistical and logical computational methods identify natural language correlation between different data categories, such as process definitions, risk statements and control data points to create applicability indexes and cross-walk lineage vectors to help risk identification and remediation. A dashboard can include outputs like checklists, automated scripts, and predicted risk indicators that help quantify and measure risk processes within the organization.

More specifically, the present disclosure is directed to leveraging natural language processing to evaluate aggregated internal efforts to address governing concerns. Embodiments are particularly applied in risk assessment. For example, the present disclosure features use an analysis of data elements from different sources, including risk metrics, internal financial institution policy data, and government regulatory requirements. Typically, the requirements expressed are in natural language. The data sources are each received by a server device that feeds the data into an adaptive risk engine that uses natural language processing to decipher which concerns are imperative in future decision-making and displays those results on a graphical user interface for users to digest.

For example, in the case of authentication, regulatory compliance may require that every device that manages Federal Deposit Insurance Corporation (FDIC) insured money must have multiple-factor authentication. Further, internally, the financial institution may have a policy requiring all two-factor authentication to include biometrics as one of the two factors to be authenticated. The adaptive risk engine consumes this data and generates recommendations accordingly. In the future, the financial institution may develop a new version of an application for banking transactions (e.g., a wallet) and conduct an internal audit of the application. It is determined that the application is lacking two-factor authentication, which is sent to the system where the system determines whether that regulation is relevant per regulatory compliance and internal policies. The system actively connects what regulations and policy requirements have been met, which creates a lineage between the data sources by using natural language processing. Further, the user sees a dashboard that indicates the issues, progress towards the results, and the like.

The adaptive risk engine processes the different data sources to determine which regulations and policies are met by making sense of the control ecosystem, correlating the control mandates and control references, and adaptive measurements. The engine detects key factors based on a statement provided by the responsible party. In the above example, the engine identified authentication as the key element to address. The device that contains the engine can generate a graphical user interface that clearly states the narrative and classifies the issue at hand. The authentication requirements are not being met. The engine then correlates the result with other internal items to be checked against, e.g., policies, requirements, regulations, technological components (e.g., an internal and external solution). Using natural language processing, the engine builds a unifying vocabulary compiled based upon all the data sources being fed into it. After the engine processes all the data, it filters for applicability, such as authentication standards.

Aspects of the present disclosure employ keyword-category matching algorithms to classify such natural language without human input. The natural language processing module employs similarity-based algorithms to classify a regulation, applying its natural language processing to generate an analysis, which computes word frequencies and n-grams that are then converted into vectors to be utilized in the model render. Natural language processing may be applied in combination with network analysis techniques to help identify risks, remediations, and the like and share these identification-related problems with relevant third parties. Sources of data that may be processed may include risk metrics, control description, policy data, authoritative sources, regulatory input and requirements, and the like.

Using similarity analysis techniques and the like that are described herein, a combination of data correlation principles create an adaptive data technology solution to identify natural language correlation between different data categories such as process definitions, risk statements, and control data points to create applicability indexes and cross-walk lineage vectors to help risk identification and remediation. Relevant parties, such as users who identified as clients of the known entity, can be served a digest of the risk assessment results.

Aspects of the present disclosure employ machine learning algorithms to leverage natural language processing to evaluate internal efforts in the aggregate to address regulatory concerns and provide an actionable dashboard to address gaps and eliminate redundancies. The system is configured to use natural language processing to parse data within an enterprise to develop risk models related to regulations to associate data with quantifying risks on an actionable dashboard. For example, applicability indexes and cross-walk lineage vectors are rendered on a dashboard to address gaps and eliminate redundancies for a user's consumption via a graphical user interface. The system recognizes that outputs like checklists, automated scripts, and predicted risk indicators automatically help quantify and measure risk processes without human input.

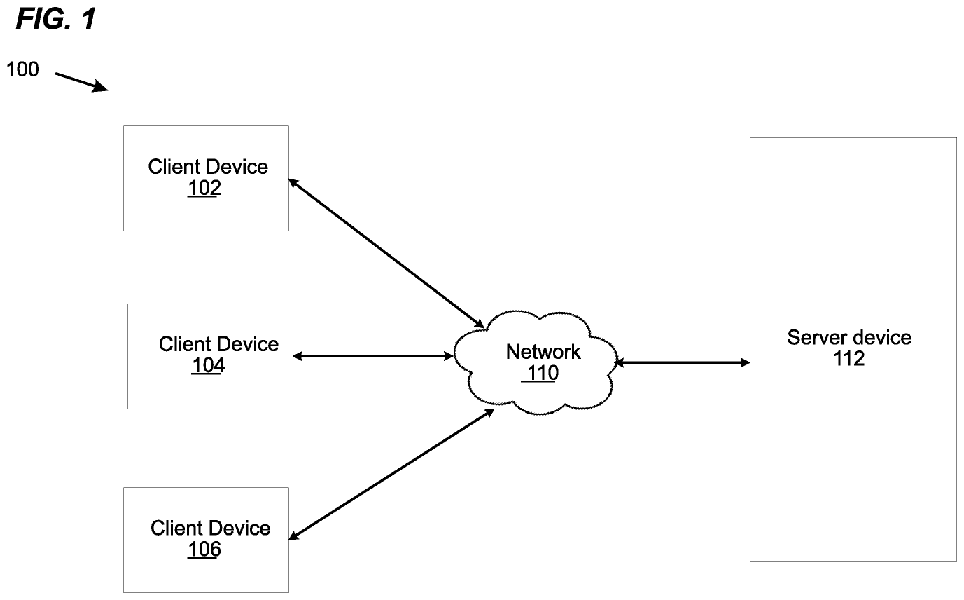

FIG. 1 schematically shows aspects of an example system 100 of the present disclosure. The system 100 includes client electronic devices 102, 104, and 106, and a server device 112.

The server computer 112 (or “server”) can be managed by, or otherwise associated with, an enterprise (e.g., a financial institution such as a bank, brokerage firm, mortgage company, or any other money lending enterprise) that uses the system 200 for risk assessments.

Each client electronic device 102, 104, 106 can be associated with one of the parties involved in the risk assessment process, such as the customer, the lender, a real estate broker or agent, an attorney, an insurance provider, an appraiser, etc.

The client electronic devices 102, 104, 106 include input devices by which the server computer 112 obtains data. The server computer 214 can also obtain data via other input devices, which can correspond to any of the electronic data acquisition devices described above, such as links to third-party data stores (e.g., through an application programming interface), a microphone, a camera, an image scanner, a web crawling machine, a transaction-card reader, biometric identity devices, etc.

An automatic speech recognition device and natural language processor used by server 112 can digitalize the speech and parse the digitalized speech into data objects to build a new context model and/or contextualize the data objects. An image scanner used by the server computer can obtain data from a paper document and use the data in context modeling and/or contextualizing of the scanned data. A web crawling machine used by the server computer can obtain data from various webpages containing loan-relevant information and use the data in context modeling and/or contextualizing the crawled data. The system 100 can be connected via a network 110 to a client device 102, 104, 106 that automatically obtains information related to regulatory and policy concerns. The server computer can use electronic biometric identity devices, such as the face, eye, and/or fingerprint scanners, to confirm a user's identity or another relevant party during one or more stages of the risk assessment process.

A model organizes data attributes and standardizes how the data attributes relate to one another. Necessarily, the creation of the model precedes the creation of the initial category data.

In this example, regardless of the context type of the context model, each context model is defined in an n-dimensional virtual space (e.g., a vector space) made up of segments having segment elements, where each segment element represents one of the dimensions of the space. Segments can be added or modified as the system learns, e.g., by supervised or unsupervised learning, from acquired data. For example, the system 100 can develop and refine its context models as it handles more and more regulations and policies. For a new risk assessment, as data comes in, the data is associated with the appropriate context type and analyzed and placed in a cluster in the n-dimensional virtual space based on the data's relationship or closeness to a cluster or clusters, e.g., by matching the segment to an already learned segment with at least a predefined minimum confidence. Based on the n-dimensional space placement, one or more automated actions can occur. Alternatively, the data is identified as an exceptional event that is passed on to a human (e.g., personnel of the financial institution via an electronic device) to review.

Groups of segment elements can be assigned a category, including one of a process definitions category, risk statements category, and control data points category.

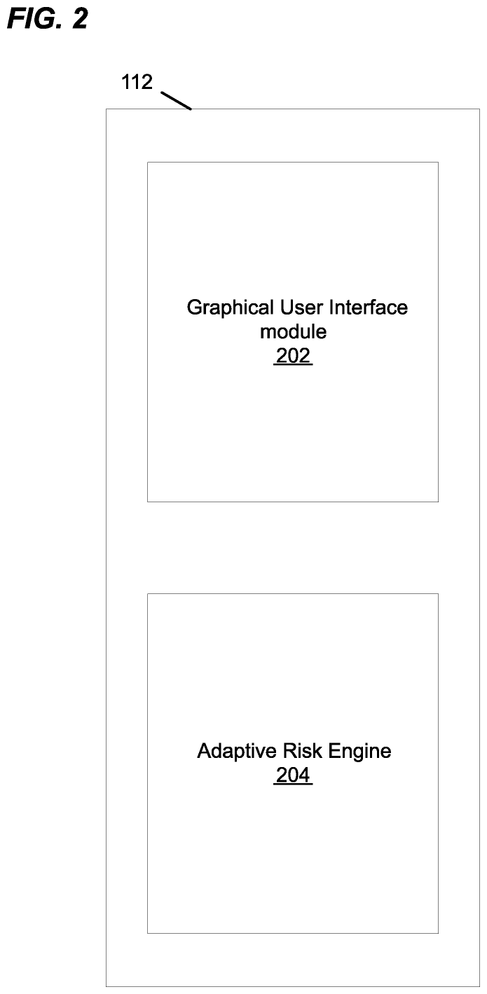

FIG. 2 schematically shows aspects of a server device 112 of the present disclosure. The server device 112 includes a graphical user interface module 202 and an adaptive risk engine 204.

The graphical user interface module 202, rendered from the server 112, provides diagnostic or updated progress of results, such as evaluating identified issues, prediction models associated with applicable regulatory and policy rules, metric of determining progress in addressing issues, action items in connection to FIG. 1, for facilitating human confirmation or computer-derived determinations such as actions, recommendations, diagnoses, linkages, or other such services.

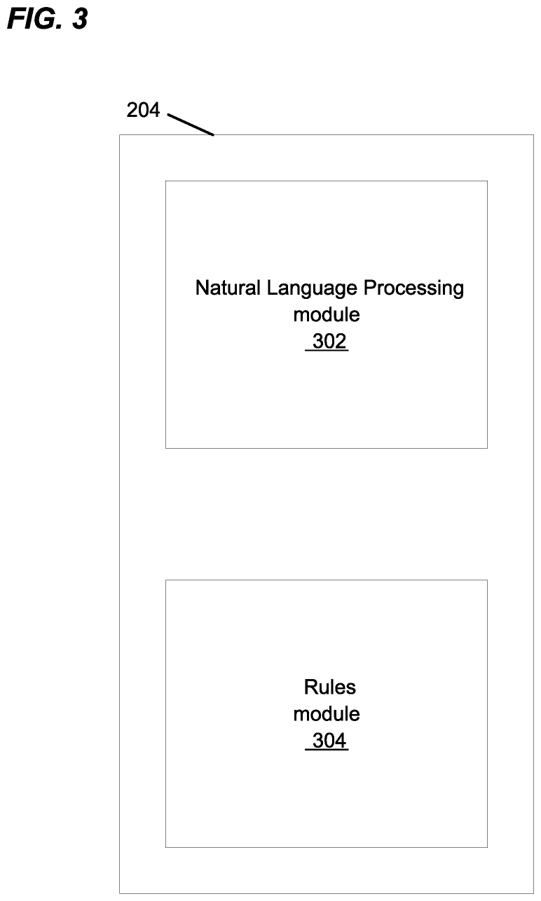

FIG. 3 schematically shows aspects of the adaptive risk engine 204 of the present disclosure. The adaptive risk engine 204 includes a natural language processing module 302 and a rules module 304.

The natural language processing module 302 determines a category from the text summary of the data source. The natural language processing module 302 may use one or more natural language processing agents to process the received regulation and policy requirements data into consumable content, which a user may use to assist in informed decision-making to help risk identification and remediation. The natural language processing module 302 is adaptive to the user's needs by generating a model that can then be used to improve tasks such as human-computer interface, information retrieval, information extraction, machine translation, and question answering.

The rules module 304 will determine if the predicted result violates any predetermined client-specific rules for predicted results generated from the model. If a predicted result violates a client-specific rule stored in the rules module 304, then the issue will be prompted on the graphical user interface 202 accordingly for attention. If a predicted result does not violate a client-specific rule predetermined in the rules module 304, it remains to be trained in the rendering model. The rules module 304 is enabled to change based on any use case showing how flexible the adaptive risk engine 204 is able to accommodate virtually any client needs, no matter how differently the client needs may operate relative to one another.

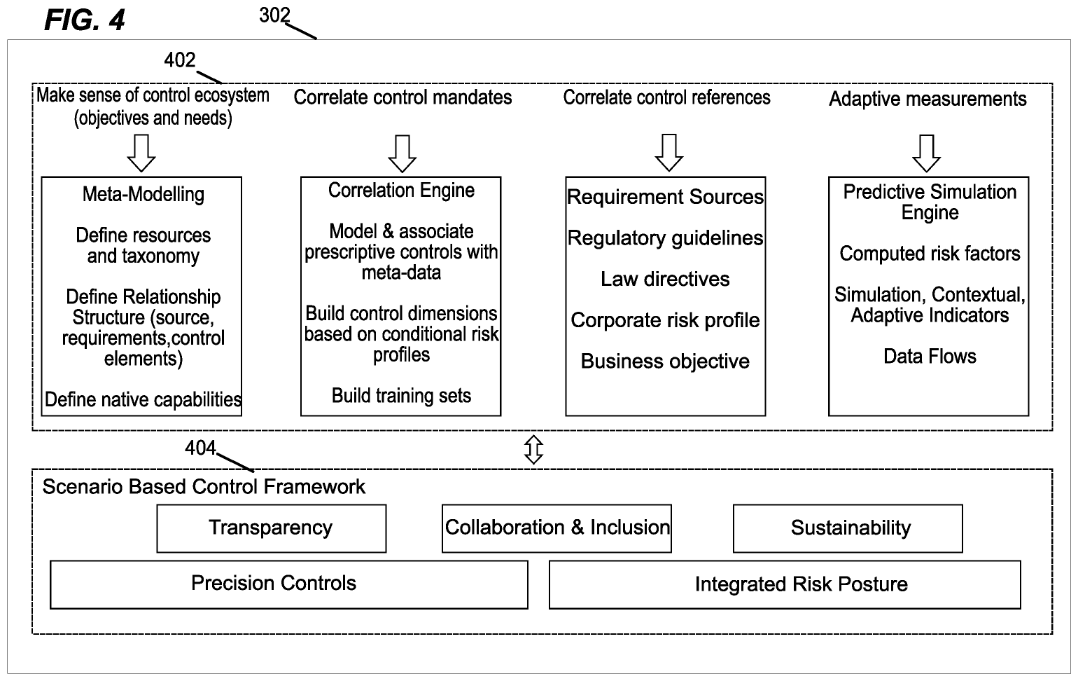

FIG. 4 schematically shows aspects of the natural language processing module 302 of the present disclosure. The natural language processing module 302 includes an engines module 402 and a scenario-based control framework 404.

The engines module 402 contains the modules for meta-modeling, correlating, requirements, and prediction simulation. The engines module 402 includes three layers to operate: (1) data models, (2) computational resources and (3) data to build a fully functional solution. Data creates the structure and meta-definitions that would represent entities (e.g., risk, control, policies) and relationships between entities. The data further describes the meta-elements that must exist to identify affinity levels being direct correlation or indirect. Last, data enables the data model to be solution agnostic and API-based to enable different data sources to co-exist.

The data models establish the algorithmic capabilities that would be required to parse, select, predict, calculate and decide different aspects of the solution using public algorithms and parametric data that is relevant for the uses cases being exercised using supervised or unsupervised techniques.

The computational resources apply and use the data relationship definitions to train the models and situations that would lead to policy, process, risk and control identifications and cerate the correlated matrix of causality, applicability, impact analysis to be used to exercise core functions such as “stress testing (statement, entity)”, “correlation (statement, entity 1, entity 2)” and “query (statement, entity*)”.

The natural language processing module 302 determines a category from the text summary of the data source. The natural language processing module 302 may use one or more natural language processing agents to process the received regulation and policy requirements data into consumable content, which a user may use to assist in informed decision-making to help risk identification and remediation. The natural language processing module 302 is adaptive to the needs of the user by generating a model that can then be used to improve tasks such as human-computer interface, information retrieval, information extraction, machine translation, and question answering.

The natural language processing module 302 uses meta-modeling to make sense of the control ecosystem by determining the desired objectives and needs. The metamodeling can include defining resources and taxonomy, defining relationship structure (such as source, requirements, control elements, and the like), and defining native capabilities.

The natural language processing module 302 uses a correlation engine to correlate control mandates, such as modeling to associate prescriptive controls with meta-data, building control dimensions based on conditional risk profiles, and building training sets.

The natural language processing module 302 uses requirement sources to correlate control references, such as regulatory guidelines, law directives, corporate risk profiles, and business objectives.

The natural language processing module 302 uses a predictive simulation engine for adaptive measurements, such as computing risk factors, simulations, contextuals, adaptive indictors, and data flows.

The scenario-based control framework 404 interacts with the engines module 402 to account for business-related objectives, such as transparency, collaboration & inclusion, sustainability, precision controls, integrated risk posture, and the like. Collaboration and inclusion may involve using a collaborative filtering algorithm that includes hyperparameters for automated machine learning, such as Privacy_Idx, Confidentiality_idx=4, and Availability_idx=2, as control requirements and recommendations in the adaptive control system.

Sustainability may be considered control element metadata in a control dependency view, which is required for discrete hyperparameter analysis and recommendation systems. Other qualities similar to sustainability may include observability, frequency, and maturity. Other control element meta-data may include experience indicators (such as a confidence percentage, trust percentage, and reliance percentage), scorecard indicators (such as functions and values), service (such as relevance percentage and complexity percentage), market (such as exposure percentage and competitors percentage), thresholds (such as limits, numbers of events, time of events), and external intel index (such as CVE and ISAC). Further, the control dependency view can contain a customer success view (presenting such service, ethics, and privacy), a business view of operations, a process flow displaying normal versus predicted, a risk control view of exceptional and abnormal occurrences, and a resources dependency view of people, tools, and technologies.

Regarding control element meta-data, a textual representation of the control appeal benefits the rating, cost avoidance, productivity result, and revenue that controls generate. The core statement is a free text format that captures the business, legal, or natural language that the control was generated or triggered. The attributes and measurable functions (known as parametric definitions) are the ranges, values, or data domain specifications that are expected. Predicative logic is used in decision trees or supporting complex ramifications that cannot be determined from previous events and require additional data (such as, next day or sum of ongoing events). Categorization is used in many ways to relate to the control being quantifiable for searching, filtering, and relevance. Categorization also includes weighted tags, labels, domain sets, numeric values, and scoring systems. Timing can be a single date (including from, until, expiration) or a scheduled data event (such as, from/until, active/disabled). Location awareness refers passively or actively determining the location (such as geo-positioning).

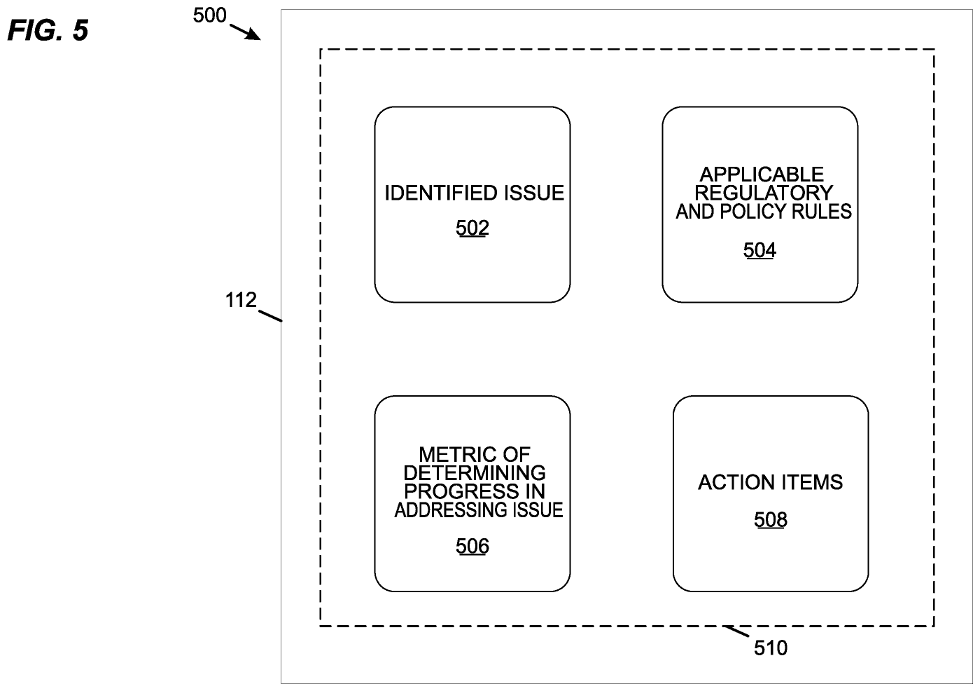

The control framework 404 interacts with the engines module 402 to offer precision control services. These services create proper control lenses with abstraction and capabilities that can be applied to multiple configurations. It can also understand the ecosystem dynamic (such as input, output, triggers) that generates, interacts, or depends on control objectives. The services can map internal and external customers and control lifecycles, such as definitions, requests, changes, dependencies, atomicity, consistency, usage, effectiveness, and reuse. Further, the services can review and correlate taxonomies as a common reference. The baseline and benchmark harmonize controls in qualitative and quantitative ways and deliver adaptive control functionality via the precision control services. Use cases of the precision control services, including control set recommendations based on business requirements, control automation based on measure technology risks, and predictive controls based on trained data and what-if scenarios. The precision controls output content and format the content via automated scripts (32-th) and checklists (6-th). The content can include control objectives (6-th), control parameters (3-rd), and control conditions (20-th). FIG. 5 schematically shows aspects of the server device 112 rendering a dashboard 500 on a graphical user interface 510 of the present disclosure. The graphical user interface 510 display of a dashboard 500 includes an identified issues module 502, an applicable regulatory and policy rules module 504, a metric of determining progress in addressing issue module 506, and an action items module 508. The dashboard 500 allows the user to digest the information generated from the adaptive risk engine 204.

The dashboard 500 displays an identified issues module 502 that conveys problems that were come upon while during the adaptive risk engine's 204 processes. For example, authentication requirements not meeting threshold requirements per internal policy requirements may be displayed by an identified issues module 502.

The dashboard 500 displays applicable regulatory and policy rules module 504 that conveys the relevant requirements to be met. For example, regulatory FDIC rules regarded insured money, and an internal company policy regarding authentication of a device may be displayed by an applicable regulatory and policy rules module 504.

The dashboard 500 displays a metric of determining progress in addressing issue module 506 that conveys the progress of an issue being solved and requirements being met. For example, a percentage may be rendered to present the evolution to meet requirement thresholds.

The dashboard 500 displays an action items module 508 that renders outstanding tasks that have not been met. For example, if a user has a task that is required to be met in order to advance the user's objective further, the task would be presented to the user in a digestible format and manner.

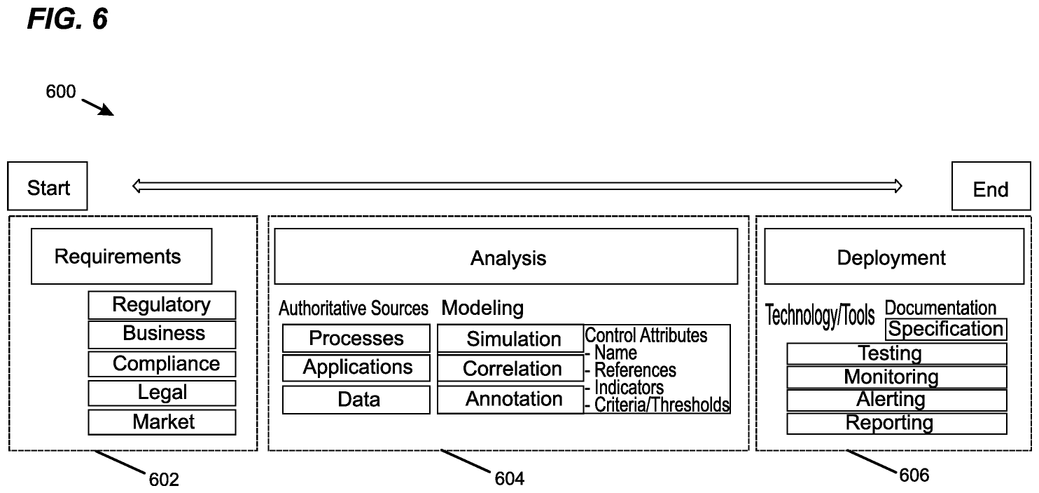

FIG. 6 shows a schematic representation of an example process 600 in accordance with the present disclosure. Data is obtained and evaluated at each stage in the process, and one or more actions occur. The actions at each stage can be managed and advance in parallel, e.g., simultaneously. Thus, while the process 600 reflects a general flow of progression for a given risk assessment, the specific stages need not be managed in the depicted sequence.

The process 600 includes a requirements stage 602. In the requirements stage 602, data about the requirements and policies is obtained and data reflecting basic parameters of the risk assessment, such as regulatory, business, compliance, legal, and market requirements.

The process 600 includes an analysis stage 604. In the analysis stage 604, data about the requirements and policies, applications, and processes are used to generate a model denoting analytical data, such as simulations, correlations, and annotations. Control attributes may include name, references, indicators, criteria, thresholds, and the like. The classified data is used in showing a lineage between the data and the natural language processing model's results.

The process 600 includes the deployment stage 606. In the deployment stage 606, technology tools and documentation are produced for digesting, rendering, and maintaining results on a dashboard. The technology tools may include means for testing, monitoring, alerting, reporting, and the like. Documentation may consist of specifications and the like.

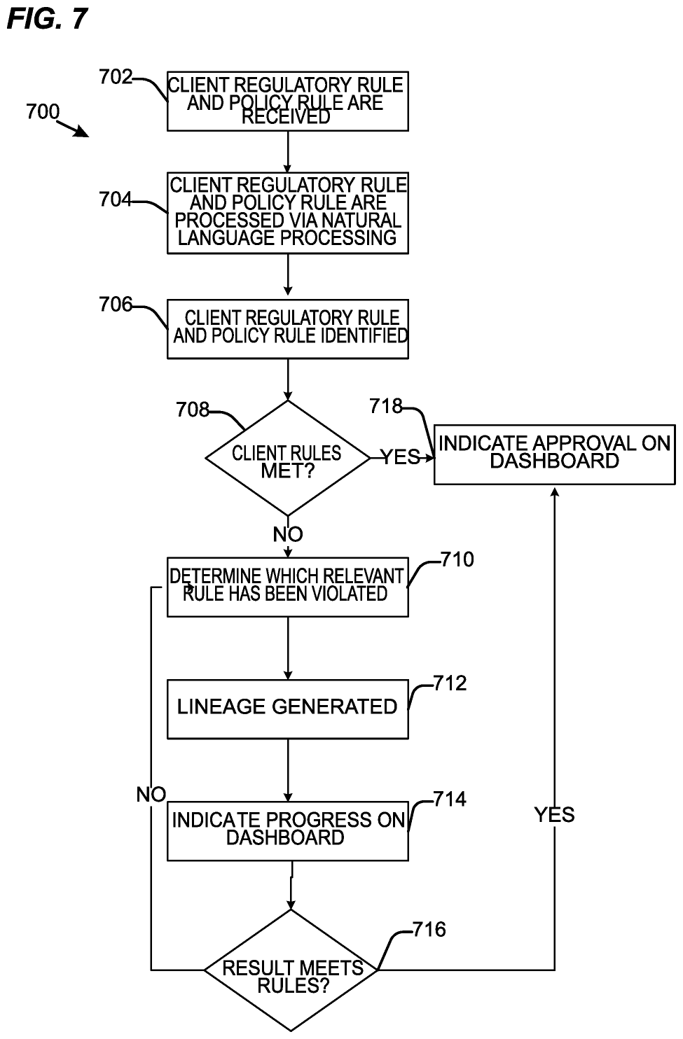

Referring to FIG. 7, an example method 700 of using an already built and saved model (using the process 600) for incorporating obtained data into one or more stages of the risk assessment process to perform one or more actions concerning the impacted assessments and/or to modify the already built model, will be described. All steps of the method 700 can be performed automatically by the system processors executing computer-readable instructions stored on non-transitory computer-readable storage.

In the example, method 700 applied to received regulatory requirements and policy rules, at step 702, the requirements and policies are acquired by the server computer of the financial institution from an external or internal source, e.g., from the FDIC's web site, from the financial institution's intranet page, and the like. Data from the sources are extracted using a data extraction tool run or used by the financial institution's server computer. In some examples in the data acquisition step 702, words extracted from the documents or web pages are grouped with other words that are semantically similar.

At step 704, the acquired data is prepared by identifying the types of data it contains, e.g., by parsing the data. For example, data extracted from a regulatory requirement or internal policy document can include guidelines, directives, business objectives, etc. Step 704 processes the received data via natural language processing to generate a model that can be learned from and digested by a user.

At step 706, the extracted and prepared data is identified and categorized accordingly. Step 706 can include organizing groups of data elements by assigning each group to one of a plurality of predefined categories described above, such as a process definitions category, risk statements category, and control data points category.

The segment is then positioned at step 708, where it is determined if the client rules are met as predetermined in the rules engine, including regulatory and policy rules. If it is determined that no rules have been violated (i.e., the client rules have been followed and met), automated notification of approval can be issued and indicated on the dashboard to be viewed and digested by users, step 718. If it is determined that at least one client rule has been violated (i.e., the client rules have not been followed and met), the method 700 processes to step 710.

At step 710, an action occurs with respect to determining which relevant rule has been violated and based on the modeling at step 708 and the applied rules. For example, suppose it is determined that the regulatory requirements are met in the conditions set forth in the applicable rules. In that case, the automatic action is automatically accepted occurs without human evaluation or intervention. Otherwise, the non-conforming rule rejection is still outstanding and requires attention. If the rule comes to be accepted, method 700 automatically advances.

At step 712, a lineage is generated to indicate a connection between the classified data and the generated model from natural language processing. The lineage is stored and learned from in future models to more accurately and efficiently classify received data.

At step 714, the progress is displayed on the dashboard via a graphical user interface rendered by the server device, indicating by some metric how much progress has been completed thus far in the risk assessment process.

At step 716, an action occurs with respect to determining whether the results meet the rules are required. For example, suppose it is determined that all rules have exceeded the predetermined threshold (i.e., the rules have been followed and met). In that case, automated notification of approval can be issued and indicated on the dashboard to be viewed and digested by users, step 718. If it is determined that at least one client rule has still not been exceeded by the predetermined threshold (i.e., the rules have not been followed and met), the method 700 processes to step 710.

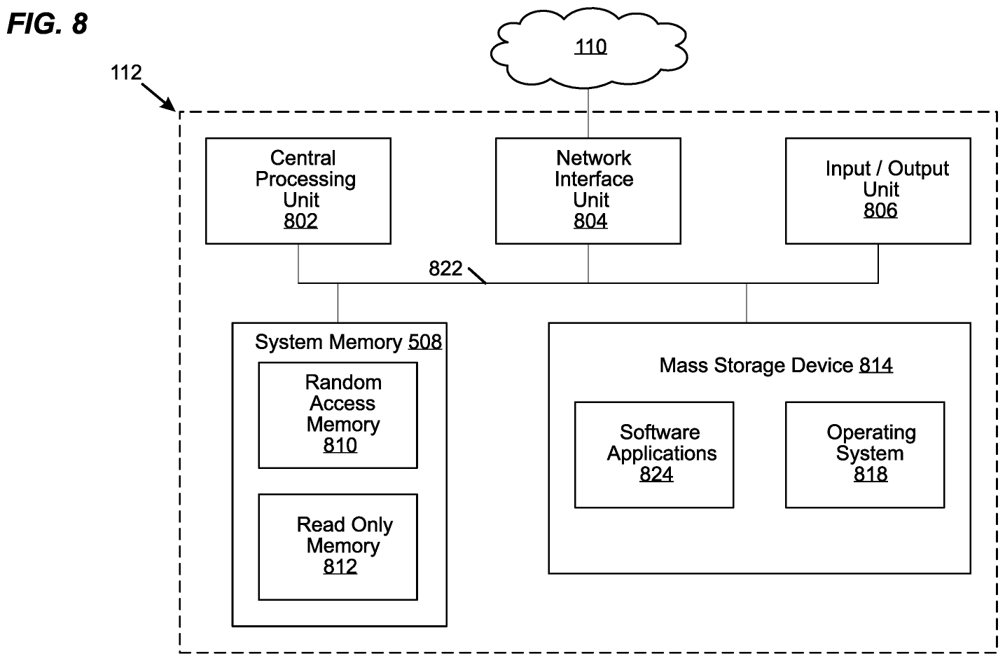

As illustrated in the example of FIG. 8, server computer 112 includes at least one central processing unit (“CPU”) 802, a system memory 808, and a system bus 822 that couples the system memory 808 to the CPU 802. The system memory 808 includes a random access memory (“RAM”) 810 and a read-only memory (“ROM”) 812. A basic input/output system that contains the basic routines that help to transfer information between elements within the server computer 112, such as during startup, is stored in the ROM 812. The server computer 112 further includes a mass storage device 814. The mass storage device 814 can store software instructions and data. A central processing unit, system memory, and mass storage device similar to that in FIG. 8 are also included in other computing devices disclosed herein (e.g., electronic client devices 102, 104, and 106).

The mass storage device 814 is connected to the CPU 802 through a mass storage controller (not shown) connected to the system bus 822. The mass storage device 814 and its associated computer-readable data storage media provide non-volatile, non-transitory storage for the server computer 112. Although the description of computer-readable data storage media contained herein refers to a mass storage device, such as a hard disk or solid-state disk, it should be appreciated by those skilled in the art that computer-readable data storage media can be any available non-transitory, physical device, or article of manufacture from which the central display station can read data and/or instructions.

Computer-readable data storage media include volatile and non-volatile, removable, and non-removable media implemented in any method or technology for storage of information such as computer-readable software instructions, data structures, program modules, or other data. Example types of computer-readable data storage media include, but are not limited to, RAM, ROM, EPROM, EEPROM, flash memory or other solid-state memory technology, CD-ROMs, digital versatile discs (“DVDs”), other optical storage media, magnetic cassettes, magnetic tape, magnetic disk storage or other magnetic storage devices, or any other medium which can be used to store the desired information and which can be accessed by the server computer 112.

According to various embodiments of the invention, the server computer 112 may operate in a networked environment using logical connections to remote network devices through network 110, such as a wireless network, the Internet, or another type of network. The server computer 112 may connect to network 110 through a network interface unit 804 connected to the system bus 822. It should be appreciated that the network interface unit 804 may also be utilized to connect to other types of networks and remote computing systems. The server computer 112 also includes an input/output controller 806 for receiving and processing input from a number of other devices, including a touch user interface display screen or another type of input device. Similarly, the input/output controller 806 may provide output to a touch user interface display screen or other output devices.

As mentioned briefly above, the mass storage device 814 and the RAM 810 of the server computer 112 can store software instructions and data. The software instructions include an operating system 818 suitable for controlling the operation of the server computer 112. The mass storage device 814 and/or the RAM 810 also store software instructions and applications 824, that when executed by the CPU 802, cause the server computer 112 to provide the functionality of the server computer 112 discussed in this document. For example, the mass storage device 814 and/or the RAM 810 can store the natural language processing module 302, the adaptive risk engine 204, the graphical user interfaces 202, and the rules module 304 (FIG. 2 and FIG. 3).

Although various embodiments are described herein, those of ordinary skill in the art will understand that many modifications may be made thereto within the scope of the present disclosure. Accordingly, it is not intended that the scope of the disclosure in any way be limited by the examples provided.

1. A system for managing risk, comprising:
one or more processors; and
non-transitory computer-readable storage encoding instructions which, when executed by the one or more processors, causes the system to:
receive data associated with rules from one or more data sources;
parse the data into individual data elements;
associate the individual data elements with category types, including to:
process the individual data elements using a natural language processing module to identify one of the category types;
generate a model using the one of the category types identified by the natural language processing module; and
based on the one of the category types, create a lineage vector in an n-dimensional vector space, where each dimension of the lineage vector represents a distinct attribute or characteristic relevant to a lineage of each of the individual data elements, including an origin, a transformation, and a relationship of each individual data element to other data elements;
train the natural language processing module to classify later received data based on at least the lineage vector;
generate an action associated with the model, wherein the action is subjected to a validation process according to one or more authentication standards to verify compliance with the rules from the one or more data sources; and
automatically perform the action associated with the model based on the one of the category types.

2. The system of claim 1, further comprising instructions which, when executed by the one or more processors, causes the system to train the model with initial category data.

3. The system of claim 1, wherein the one of the category types comprises process definitions.

4. The system of claim 1, wherein the one of the category types comprises risk statements.

5. The system of claim 1, wherein the one of the category types comprises control data points.

6. The system of claim 1, further comprising instructions which, when executed by the one or more processors, causes the system to be populated with predetermined client-specific rules.

7. The system of claim 6, wherein the predetermined client-specific rules include a predetermined threshold set by a client.

8. The system of claim 1, wherein an internal audit determines whether predetermined client-specific rules have been met.

9. The system of claim 8, wherein an internal audit results are sent to a responsible party to create an action plan.

10. (canceled)

11. A computer-implemented method of performing risk assessment, comprising:
receiving risk-related data associated with rules from one or more data sources, wherein the one or more data sources contains risk metrics;
parsing the risk-related data into individual data elements;
associating the individual data elements with at least one risk category type, including:
processing the individual data elements using a natural language processing module to identify the at least one risk category type;
generating a model using the at least one risk category type identified by the natural language processing module; and
based on the at least one risk category type, creating a lineage vector in an n-dimensional vector space, where each dimension of the lineage vector represents a distinct attribute or characteristic relevant to a lineage of each of the individual data elements, including an origin, a transformation, and a relationship of each individual data element to other data elements;
training the natural language processing module to classify later received data based on at least the lineage vector;
generating an action associated with the model, wherein the action is subjected to a validation process according one or more authentication standards to verify compliance with the rules from the one or more data sources; and
automatically performing the action associated with the risk assessment based on the at least one risk category type displayed on a dashboard for reporting.

12. The method of claim 11, further comprising training the model with initial category data.

13. The method of claim 11, wherein the at least one risk category type comprises process definitions.

14. The method of claim 11, wherein the at least one risk category type comprises risk statements.

15. The method of claim 11, wherein the at least one risk category type comprises control data points.

16. The method of claim 11, further comprising generating a rules engine that is populated with predetermined client-specific rules.

17. The method of claim 16, wherein the predetermined client-specific rules includes a predetermined threshold set by a client.

18. The method of claim 11, wherein an internal audit determines whether predetermined client-specific rules have been met.

19. A system for managing a risk assessment for a financial industry, comprising:
one or more processors; and
non-transitory computer-readable storage encoding instructions which, when executed by the one or more processors, causes the system to:
receive financial data associated with requirements from one or more data sources, wherein the one or more data sources include a financial institution;
parse the financial data into individual data elements;
associate the individual data elements with one of a plurality of financial category types, including to:
process the individual data elements using a natural language processing module to identify a financial category type of the plurality of financial category types;
generate a model using the financial category type identified by the natural language processing module; and
based on the financial category type, create a lineage vector in an n-dimensional vector space, where each dimension of the lineage vector represents a distinct attribute or characteristic relevant to a lineage of each of the individual data elements, including an origin, a transformation, and a relationship of each individual data element to other data elements;
train the natural language processing module to classify later received data based on at least the lineage vector;
generate an action associated with the model, wherein the action is subjected to a validation process according to one or more authentication standards to verify compliance with the requirements from the one or more data sources; and
automatically perform the action associated with the risk assessment based on the one of the plurality of financial category types displayed on a graphical user interface on a financial institution device.

20. The system of claim 19, further comprising automatically generating a notification to be displayed on the graphical user interface that a requirement associated with the model has been met.
